(19) United States
(12) Patent Application Publication
(10) Pub. No.: US 2015/0281886 A1
(43) Pub. Date: Oct. 1, 2015

(54) METHOD AND APPARATUS FOR IMPROVED GEOFENCING BACKGROUND

(71) Applicant: Itai Steiner, Tel Aviv (IL)

(72) Inventor: Itai Steiner, Tel Aviv (IL)

(21) Appl. No.: 14/227,070

(22) Filed: Mar. 27, 2014

(51) Int. Cl. H04W 4/02

(52) U.S. Cl. CPC H04W 4/021

(57) ABSTRACT

The disclosure generally relates to a method and apparatus for determining a coarse geofence of a mobile device. An exemplary method includes: identifying, at the device, a first perimeter for the location, the first perimeter enclosed by a geofence region; identifying a second perimeter for the location, the second perimeter enclosing the geofence regions; and determining if the device is one of an inside the first perimeter or an outside the second perimeter. The exemplary steps can be implemented as part of a software, a firmware or a dedicated chipset.

### BACKGROUND

1. Field

The disclosure relates to a method and apparatus for coarse geofence location. More specifically, the disclosure relates to a method and apparatus for improved geofence determination for a mobile device.

2. Description of Related Art

With the proliferation of mobile devices, there is an increased need for determining device location. Device location determination can be implemented by the device or by a remote server. A geofence is a virtual perimeter for a real-world geographic area. When the location-aware device of a location-based service (LBS) user enters or exits a geofence, the device receives a server-generated notification. Geofencing algorithms and systems are designed to check whether a given location (which is normally being periodically updated by location providers) is inside or outside one or more perimeters, or geofence requests. A perimeter is typically described by variety and types of figures and shapes with different levels of complexity.

Conventional geofencing is a feature in a software program that uses the global positioning system (GPS) or radio frequency identification (RFID) or any other location provider (e.g., Wi-Fi Time of Flight (ToF) based or Wi-Fi RSSI-based location engines, inertial-sensors-based location engines, Bluetooth, etc.) to define geographical boundaries. A geofence can be used as a virtual barrier to stop egress or ingress from a location.

Programs that incorporate geofencing allow the administrator to set up triggers so when a device enters or exits the boundaries defined by the administrator, a text message or email alert is sent. The notification can be direct or indirect and can be sent to the user or to an applet (App) or client software. Many geofencing applications incorporate widely available programs, including, Google Earth™, to allow administrators to define boundaries on top of a satellite view of a specific geographical area. Other applications define boundaries by longitude and latitude or through user-created and maps.

The technology has many practical uses. For example, a network administrator can set up alerts so when an office-owned device leaves the office the device can be disabled remotely. Similarly, geofencing enables a retailer to geofence a store and send coupons to customers when they crosses the geofence boundary.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 is an exemplary environment for implementing an embodiment of the disclosure;

FIG. 2 is a schematic representation of a conventional geofence;

FIG. 3 illustrates an exemplary embodiment of the disclosure;

FIG. 4 is a flow diagram of an exemplary method according to one embodiment of the disclosure;

FIG. 5 is an exemplary apparatus for implementing an embodiment of the disclosure; and

FIG. 6 is an exemplary system for implementing one or more of the disclosed embodiments.

### DETAILED DESCRIPTION

Certain embodiments may be used in conjunction with various devices and systems, for example, a mobile phone, a smartphone, a laptop computer, a sensor device, a BlueTooth (BT) device, an Ultrabook™, a notebook computer, a tablet computer, a handheld device, a Personal Digital Assistant (PDA) device, a handheld PDA device, an on board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (AV) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Institute of Electrical and Electronics Engineers (IEEE) standards (IEEE 802.11-2012, IEEE Standard for Information technology-Telecommunications and information exchange between systems Local and metropolitan area networks—Specific requirements Part 11: Wireless LAN Medium Access Control (MAC) and Physical Layer (PHY) Specifications, Mar. 29, 2012; IEEE 802.11 task group ac (TGac) (“IEEE 802.11-09/0308r12-TGac Channel Model Addendum Document”); IEEE 802.11 task group ad (TGad) (IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band, 28 December, 2012)) and/or future versions and/or derivatives thereof, devices and/or networks operating in accordance with existing Wireless Fidelity (WiFi) Alliance (WFA) Peer-to-Peer (P2P) specifications (WiFi P2P technical specification, version 1.2, 2012) and/or future versions and/or derivatives thereof, devices and/or networks operating in accordance with existing cellular specifications and/or protocols, e.g., 3rd Generation Partnership Project (3GPP), 3GPP Long Term Evolution (LTE), and/or future versions and/or derivatives thereof, devices and/or networks operating in accordance with existing WirelessHD™ specifications and/or future versions and/or derivatives thereof, units and/or devices which are part of the above networks, and the like.

Some embodiments may be used in conjunction with one way and/or two-way radio communication systems, a BT device, a BLE device, cellular radio-telephone communication systems, a mobile phone, a cellular telephone, a wireless telephone, a P612005 Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like. Some demonstrative embodiments may be used in conjunction with a WLAN. Other embodiments may be used in conjunction with any other suitable wireless communication network, for example, a wireless area network, a “piconet”, a WPAN, a WVAN and the like.

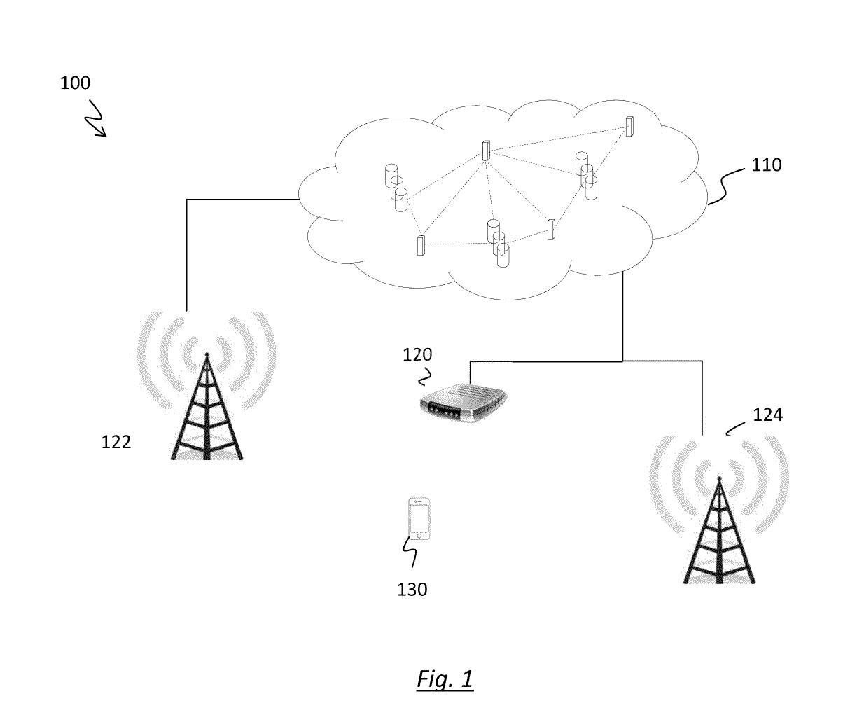

FIG. 1 is an exemplary environment for implementing an embodiment of the disclosure. Environment 100 of FIG. 1 may include a wireless communication network, including one or more wireless communication devices capable of communicating content, data, information and/or signals over a wireless communication medium (not shown). The communication medium may include a radio channel, an infrared (IR) channel, a Wi-Fi channel or the like. One or more elements of environment 100 may optionally be configured to communicate over any suitable wired communication link. Environment 100 may be an indoor environment, an enclosed area or a part of a multi-level structure.

Network 110 of FIG. 1 enables communication between environment 100 and other communication environments. Network 110 may further include servers, databases and switches. Network 110 may also define a cloud communication system for communicating with APs or Base Stations 120, 122 and 124 (interchangeably, APs). While environment 100 may have other base stations or APs, for simplicity only base stations and AP 120, 122 and 124 are illustrated. Communication between the APs and network 110 may be through a wireless medium or a through direct connection. Further, the APs may communicate with each other wirelessly or through landline. Each AP may be directly linked to cloud 110, or it may communicate with cloud 110 thought another AP (a relay switch). Each AP may define a router, a relay station, a base station or any other device configured to relay or provide radio signal to other devices.

Communication device 130 communicates with APs 120, 122 and 124. Communication device 130 may be a mobile device, a laptop computer, a tablet computer, a smartphone, a GPS or any other portable device with radio capability. While the embodiment of FIG. 1 shows device 130 as a wireless laptop, the disclosure is not limited thereto and device 130 may define any device seeking its position within an environment.

During an exemplary implementation, device 130 scans environment 100 to identify APs 120, 122 and 124. Environment 100 is not limited to Wi-Fi and may include areas defined by the Global Navigation Satellite System (GNSS) or any other geo-positioning satellites (GPS), system. A software program or an app may be used for this function. Scanning may occur continuously or after a triggering event. The triggering event can be receipt of a new beacon signal, turning on device 130 or upon opening or updating a particular app. Alternatively, scanning can occur during regular intervals (e.g., every minute).

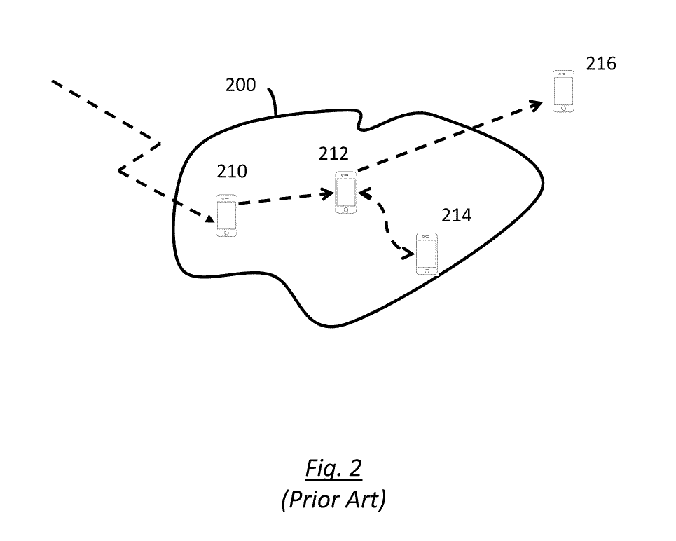

FIG. 2 is an schematic representation of a conventional geofence. In FIG. 2, geofence 200 is curved-shaped bounded area. Geofence 200 may define a building, an open space (e.g., a park), a shopping center or any other area. Geofence 200 may also define a smaller space, such as a room or a lobby area of a building. A device having geofencing capability is tracked through the perimeter of geofence 200. Specifically, the mobile device enters perimeter 200 to location 210. The device movement is tracked to locations 212 and 214 through perimeter 200. The device ultimately leaves perimeter 200 as shown by arrow 216. The device may remain at each of locations 210, 212 and 214 for a period of time.

The conventional geofencing software for mobile operating systems allow for up to 100 geofence regions per App. Network location-based services and protocols may also configure additional geofence, or area-trigger notification for the monitored device. Having multiple Apps running in the background can lead to more than 1000 geofence regions active on the device. Algorithms to check if a given point is inside or outside a perimeter depends heavily on the type of the geometric shape of the perimeter. In the case of complex perimeters, such as polygons or closed-curved lines, these algorithms require heavy computational power. For polygons, an example for such an algorithm may be Ray Casting Planner algorithm, with a complexity of O (number of polygon vertices) or worse. The so-called complexity of O is a conventional notation in computer science and is used to classify algorithms by how they respond (e.g., in their processing time or working space requirements) to changes in the input size.

Applications such as “Connected Standby”, “Always-On Always-Connected”, “Always-Located”, as well as off-load engines, may require the geofence services to be provided by a simple auxiliary/embedded CPU (and not the main application processor), when the application processor is not awake. However, the current demands to handle more than 1000 complex geofence perimeters requires many resources (i.e., memory and CPU power) at the auxiliary/embedded CPU. These contentions for the CPU power can result in system crash, inability to service the application or the quick exhaustion of battery.

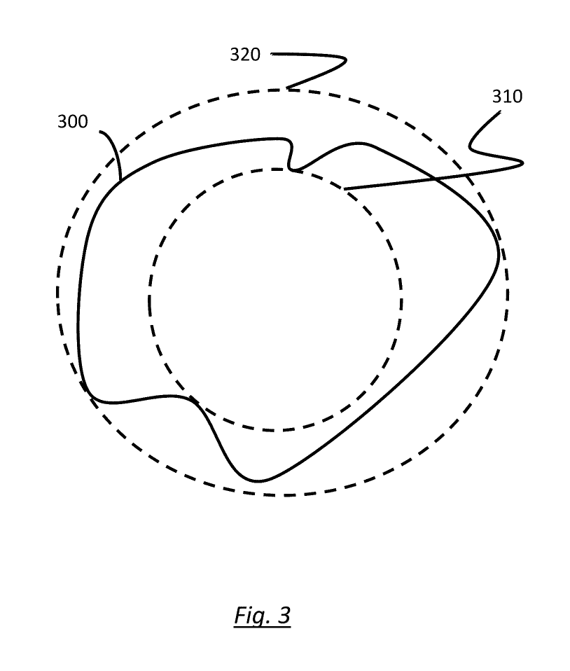

An embodiment of the disclosure significantly reduces the computational demands of the conventional geofencing software by reducing complex geometric boundaries to simple, manageable, geometric shapes. FIG. 3 illustrates an exemplary embodiment of the disclosure. In FIG. 3 perimeter 300 is a designated geofence similar to that shown in FIG. 2. In addition to perimeter 300, an inner boundary 310 and an outer boundary 320 are shown. Each of boundaries 310 and 320 may define additional geofences.

In one embodiment of the disclosure, inner boundary 310 is configured to be encompassed by geofence 300. While the embodiment of FIG. 3 shows inner boundary 310 as a circle, other geometric shapes such as triangle, square or any other polygon can be used as the inner (or the outer) boundary. In one embodiment, the inner boundary is entirely encompassed by geofence 300. Similarly, outer boundary 320 is shown to entirely encompass the perimeter 300. As with the inner boundary 310, the outer boundary can be one of circle, triangle, square, polygon or any other easily measurable geometric shape. Outer boundary 320 encompasses perimeter 300. The inner and outer boundaries can be defined by their respective radii and area. In the representative embodiment of FIG. 3, the inner boundary and the outer boundaries are concentric circles where the inner boundary is encompassed by the perimeter and the outer boundary is encompassing the perimeter.

To determine location, a first determination can be made as to the location of the inner and outer boundaries. The shape and size of the boundaries can be determined by the network administrator or by a software program. The software program may reside at the device or at a remote server as a geofence computation engine. When the computation engine is stored at a remote server, it can be wirelessly communicated to the mobile device when the device approaches a target geofence.

The geofence computation engine can determine if a given point (the input location) is inside the inner boundary (Condition A) or outside the outer boundary (Condition B). The disclosed computation is significantly less intensive and can provide an immediate answer to a majority of the geofencing determination. An associated event may include: (1) device inside the perimeter if Condition A is satisfied; (2) outside the perimeter if Condition B is satisfied; and (3) inconclusive/unknown if neither Conditions A and B is satisfied.

The computational and data requirement for the disclosed geofencing engine and method is much simpler than the computation involved with complex geofences (e.g., perimeter 300, FIG. 3) such as a polygon or a closed-shaped curved-line. The disclosed embodiment is particularly suitable for situations where fine geofencing is not required and a coarse description is sufficient.

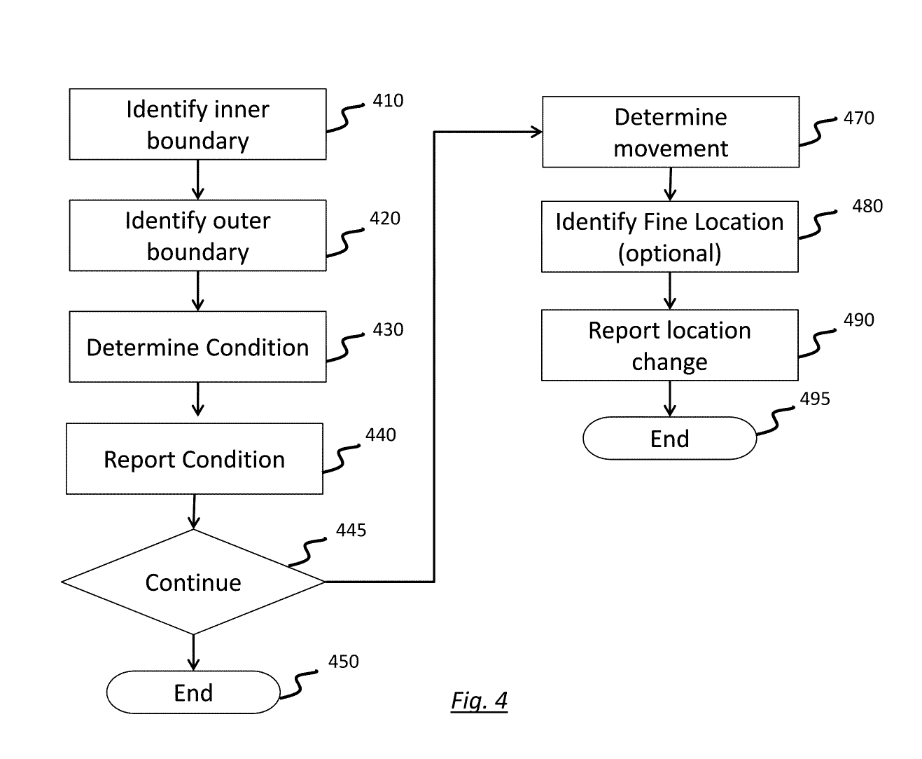

FIG. 4 is a flow diagram of an exemplary method according to one embodiment of the disclosure. The process of FIG. 4 can be implemented at a geofencing engine residing at the mobile device. Alternatively, the process can be implemented at a remote device and communicated to the mobile device, a server or both. The process starts at step 410 where the geofencing engine identifies the inner boundary. The inner boundary may also be received from the client or an upper layer software. In one embodiment, the inner boundary is entirely enclosed within the perimeter. The perimeter may be defined apriori by the network entity or network client. At step 420, the geofencing engine determines the outer boundary. The outer boundary may completely encompass the perimeter. Alternatively, the network manager or other software client or upper layer software entity (which may reside in the device) can determine the inner and outer boundaries and communicate only these boundaries to the mobile device. In this embodiment, the mobile device can only obtain certain conditions as will be discussed below.

At step 430, the geofencing engine determines a coarse geofence condition. The condition may be one of Condition A, Condition B or inconclusive/unknown. At step 440, the condition is reported to the server or the network manager. Once the coarse geofence is reported, any terms associated with the device location can be implemented. By way of example, the tracked device can be an electronic device and the device may have a requirement of staying within the perimeter. Once the coarse geofence location for device renders the device outside of the outer boundary, the network manager may remotely inactivate the device.

At step 445, determination is made as to whether to continue or end the coarse geofencing process. If the device is deemed stationary (e.g., inside the inner boundary) or well outside the outer boundary, the process may end. Alternatively, the process may run periodically to continually monitor device location even when Condition B is satisfied.

If additional movement detection is required, at step 470, the geofencing engine determines whether the device is entering/exiting the inner or outer boundaries. Device movement can be similarly reported to the network administrator or the controlling server. The geofencing process may be optionally fine-tuned at step 480 by determining device location with respect to the exact geofencing perimeter. The movement results, and optionally, the device location with respect to the geofencing perimeter can be reported at step 490. The process ends at step 495.

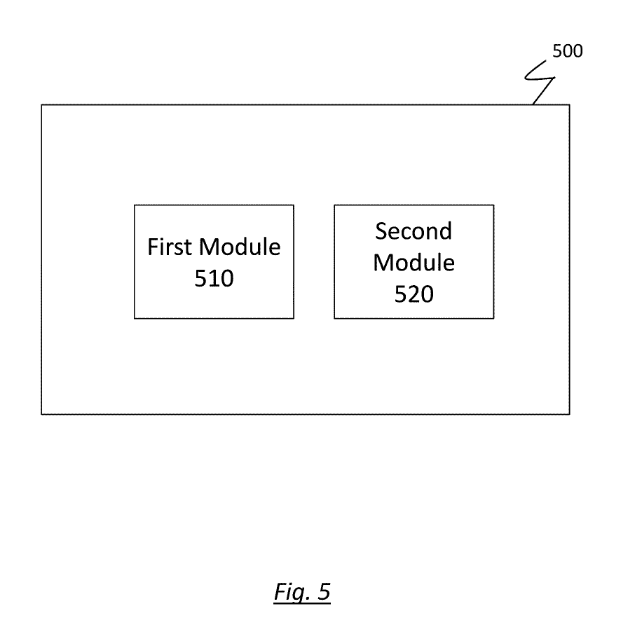

FIG. 5 is an exemplary apparatus for implementing an embodiment of the disclosure. Specifically, FIG. 5 shows device 500 which can be an integral part of a larger system or can be a stand-alone unit. For example, device 500 can define a system on chip configured to implement the disclosed methods. Device 500 may also be part of a larger system having multiple antennas, a radio and a memory system. Device 500 may be define a software or an App. In one embodiment, device 500 defines a geofence engine.

Device 500 includes first module 510 and second module 520. Modules 510 and 520 can be hardware, software or a combination of hardware and software (i.e., firmware). Further, each of modules 510 and 520 can define one or more independent processor circuits. In an exemplary embodiment, at least one of modules 510 or 520 includes a processor circuitry and a memory circuitry in communication with each other. In another embodiment, modules 510 and 520 define different parts of the same data processing circuit.

In an exemplary embodiment, device 500 can be configured to determine a coarse geofence location for a mobile device. The coarse geofence location may comprise one, two or more boundaries configured in relation to a known geofence perimeter. The determination can be done at the mobile device through geofence engine 500.

First module 510 can be configured to identify a first perimeter enclosed by the geofence region and a second perimeter enclosing the geofence region. The first and the second perimeters can correspond to the inner boundary and the outer boundary, respectively. The first module can be further configured for additional functionalities. For example, the first module may communicate (or cause to be communicated) with an external/internal server to identify the inner and the outer boundaries.

In one embodiment, the first module is configured to receive information identifying the geofence perimeter and then determine the inner or the outer boundaries. The first module can determine the boundaries as a function of the shape of the geofence perimeter. If the shape lends itself to using circular boundaries, the first module then identifies the inner and the outer boundary shapes best suited for the given perimeter. If a different shape, e.g., square, rectangle or polygon, is better suited to the perimeter, the first module can devise inner and outer boundaries that best comport with the perimeter.

In the exemplary embodiment of FIG. 5, the second module can be configured to determine if the mobile device is inside the first perimeter or outside the second perimeter. The second module can be configured to determine the coarse geofence location. The second module may also be configured to fine-tune the coarse geofence location, for example, by determining the mobile device's location with respect to actual geofence perimeter. The second module may report (or cause to be reported) the geofence location of the mobile device.

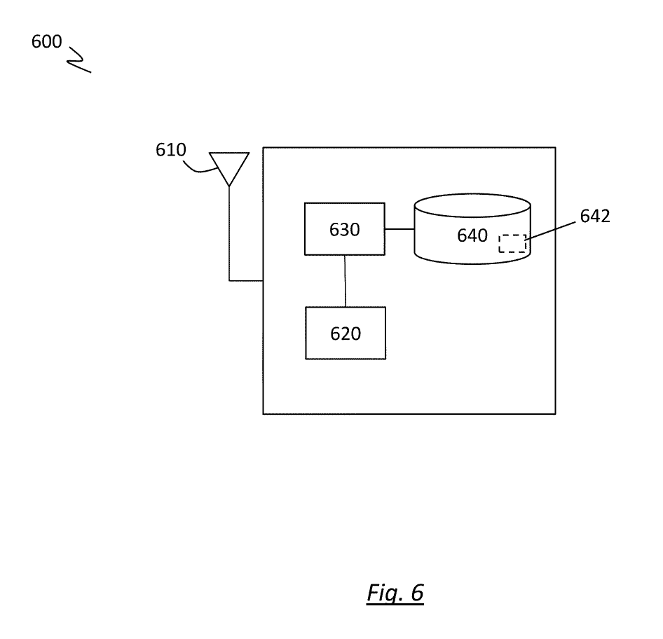

FIG. 6 is an exemplary system for implementing one or more of the disclosed embodiments. For example, the steps of any of the above-disclosed flow diagrams may be implemented at the system of FIG. 6. System 600 of FIG. 6 may define a mobile device such as a smartphone, a tablet or any device capable of wireless communication. While system 600 is shown with antenna 610, the disclosure is not limited to having one antenna. Multiple antennas can be added to system 600 such that different signals for different protocols can be received at different antennas. The signal(s) received at antenna 610 are relayed to radio 620. Radio 620 may include transceiver components such as front-end receiver components or a receiver/transmitter. Although not shown, system 600 may be connected to a WLAN or the internet backbone.

Radio 620 may convert analog signals to a digital data stream and direct the data stream to processor 630. Processor 630 may include one or more modules as discussed in relation to FIG. 5. Processor 630 may also communicate with memory circuit 640. While shown as a separate circuitry in the exemplary system of FIG. 6, it should be noted that instructions 642 can be embedded on processor 630 as firmware to obviate the addition of memory circuit 640.

Memory circuit 640 may contain instructions 642 for processor 630 to implement one or more of the steps of the exemplary methods disclosed herein. Memory circuit 640 may define a non-transitory computer readable medium containing a set of instructions to processor 630 to perform a process comprising: (1) identify a first perimeter for the location, the first perimeter enclosed by a geofence region; (2) identify a second perimeter for the location, the second perimeter enclosing the geofence regions; and (3) determine if the device is one of an inside the first perimeter or an outside the second perimeter. Instructions 642 may be programmed directly on processor 630 to obviate memory circuit 640.

The following example illustrates the construction of an Area Event trigger parameters. The implementation uses the Open Mobile Alliance's (OMA) Secure User Plane Location (SUPL) standard. The parameter is required if the trigger type is set to Area Event; that is, the user device (i.e., SET) enters or exits a predefined area.

The Area Event Trigger can be one of the following types: (1) Entering: The SET reports to the a remote server (i.e., SLP) when it first detects that it is inside the predefined area. If repeated reporting is present, the SET then reports once more for each time it detects that it has re-entered the predefined area after having left in the meantime. (2) Inside: The SET then reports to the SLP when the SET is within the predefined area. (3) Outside: The SET reports to the SLP when it is outside the predefined area. (4) Leaving: The SET reports to the SLP when it first detects that it is outside the predefined area. If repeated reporting is present, the SET then reports once more for each time it detects that it has exited the predefined area after having been inside again. These events are summarized at TABLE 1 below.

TABLE 1
Exemplary Implementation of OMA's SUPL

| Parameter | Presence | Value/Description |
|---|---|---|
| Area Event Type | Mandatory | Describes the Area Event |
| | | Trigger type. This parameter |
| | | describes what kind of event |
| | | should trigger a report. The |
| | | exemplary valid types include: |
| | | Entering event type |
| | | Inside event type |
| | | Outside event type |
| | | Leaving event type |
| Location Estimate | Mandatory | The value of this parameter is |
| | | “true” or “false”. If true, it |
| | | indicates the location estimate |
| | | is required. If false, it |
| | | indicates the location estimate |
| | | is not required. For SET- |
| | | initiated triggered services this |
| | | parameter is not useful and |
| | | therefore in this case it shall |
| | | be ignored by the SLP. |
| Repeated Reporting | Optional | Defines the parameters for |
| | | repeated reporting. If not |
| | | present, only one report shall |
| | | be sent. |
| Geographic Target | Optional | Defines a list of geographic |
| Area List | | target areas. This parameter is |
| | | optional. |
| | | Maximum number of areas |
| | | can be according to element |
| | | Max Geo Target Area in SET |
| | | capabilities. |
| Geographic Target | Mandatory | Defines a geographic target |
| Area | | area in terms of either: |
| | | Circular Area |
| | | Elliptical Area |
| | | Polygon |

In an exemplary embodiment, the Area Event Type (AET) may comprise the additional types of inclusive area and the Geographic Target Area may include the new inner-outer ring (i.e., boundary) area. The two boundaries (inner and outer boundaries) described above are mapped to the AET.

The following is an exemplary code for setting or configuring the inner and the outer boundaries according to one implementation of the disclosure:

InnerOuterRingArea ::= SEQUENCE {
innerRingCoordinate Coordinate,
innerRingRadius INTEGER(1..1000000), -- radius in meters
outerRingCoordinate Coordinate,
outerRingRadius INTEGER(1..1000000), -- radius in meters}

The following examples pertain to further embodiments of the disclosure. Example 1 includes a method a method for determining a coarse geofence location of a mobile device, the method comprising: identifying, at the device, a first boundary for the location, the first boundary enclosed by a geofence perimeter; identifying a second boundary for the location, the second boundary enclosing the geofence perimeter; and determining if the device is inside the first boundary or outside the second boundary.

Example 2 is directed to the method of example 1, wherein the first boundary and the second boundary overlap.

Example 3 is directed to the method of example 1, wherein each of the first boundary and the second boundary is defined by a respective center coordinates and an area.

Example 4 is directed to the method of example 1, further comprising defining an inconclusive condition if the device is not inside the first boundary and not outside the second boundary.

Example 5 is directed to the method of example 4, further comprising determining if the device is within the geofence perimeter when the inconclusive conditions exist.

Example 6 is directed to the method of example 1, further comprising determining the first boundary and the second boundary as geometric areas relevant to the geofence perimeter.

Example 7 is directed to the method of example 1, further comprising notifying a server when the mobile device is either entering or exiting one of the first or the second boundaries.

Example 8 is directed an apparatus to detect a coarse geofence location of a mobile device, comprising: a first module configured to identify a first boundary enclosed by the geofence perimeter and a second boundary enclosing the geofence perimeter; a second module configured to determine if the mobile device is inside the first boundary or outside the second boundary.

Example 9 is directed to the apparatus of example 8, further comprising a third module to transmit the coarse geofence location of the mobile device relative to the first boundary and/or the second boundary.

Example 10 is directed to the apparatus of example 8, wherein the first boundary and the second boundary overlap.

Example 11 is directed to the apparatus of example 8, wherein each of the first boundary and the second boundary is defined by a respective center coordinates and an area.

Example 12 is directed to the apparatus of example 8, wherein the first module is further configured to define an inconclusive condition if the mobile device is not inside the first boundary and not outside the second boundary.

Example 13 is directed to the apparatus of example 12, wherein one of the first or the second module is further configured to determine if the mobile device is within the geofence perimeter when the inconclusive conditions exist.

Example 14 is directed to the apparatus of example 8, further comprising a processor configured to determine the first boundary and the second boundary as geometric areas relevant to the geofence perimeter.

Example 15 is directed to the apparatus of example 8, wherein one of the first or the second module is further configured to notify a server when the mobile device enters or exists one of the first or the second boundaries.

Example 16 is directed to a system comprising: one or more antennas to transmit the signal; a radio to communicate with the one or more antennas; and a first module configured to identify a first boundary encompassed by the geofence region and a second boundary encompassing the geofence perimeter; a second module configured to determine if the mobile device is inside the first boundary or outside the second boundary.

Example 17 is directed to the system of example 16, further comprising a third module to transmit a coarse geofence location of the mobile device relative to the first boundary and/or the second boundary.

Example 18 is directed to the system of example 16, wherein the first boundary and the second boundary overlap.

Example 19 is directed to the system of example 16, wherein each of the first boundary and the second boundary is defined by a respective center coordinates and an area.

Example 20 is directed to the system of example 16, wherein the first module is further configured to define an inconclusive condition if the mobile device is not inside the first boundary and not outside the second boundary.

Example 21 is directed to the system of example 16, wherein one of the first or the second module is further configured to notify a server when the mobile device enters or exists one of the first boundary or the second boundary.

Example 22 is directed to a computer-readable storage device containing a set of instructions to cause a computer to perform a process comprising identifying, at the device, a first boundary for the location, the first boundary enclosed by a geofence perimeter; identifying a second boundary for the location, the second boundary enclosing the geofence perimeter; and determining if the device inside the first boundary or an outside the second boundary.

Example 23 is directed to the computer-readable storage device of example 22, wherein the instructions further cause the computer to define an inconclusive condition if the device is not inside the first boundary and not outside the second boundary.

Example 24 is directed to the computer-readable storage device of example 22, wherein the instructions further cause the computer to determine if the device is within a geofence perimeter when the inconclusive conditions exist.

Example 25 is directed to the computer-readable storage device of example 22, wherein the instructions further cause the computer to determine the first boundary and the second boundary as geometric areas relevant to the geofence perimeter.

While the principles of the disclosure have been illustrated in relation to the exemplary embodiments shown herein, the principles of the disclosure are not limited thereto and include any modification, variation or permutation thereof.

What is claimed is:

1. An apparatus to detect a coarse geofence location of a mobile device, comprising:
a first module configured to identify a first boundary enclosed by the geofence perimeter and a second boundary enclosing the geofence perimeter;
a second module configured to determine if the mobile device is inside the first boundary or outside the second boundary.

2. The apparatus of claim 1, further comprising a third module to transmit the coarse geofence location of the mobile device relative to the first boundary and/or the second boundary.

3. The apparatus of claim 1, wherein the first boundary and the second boundary overlap.

4. The apparatus of claim 1, wherein each of the first boundary and the second boundary is defined by a respective center coordinates and an area.

5. The apparatus of claim 1, wherein the first module is further configured to define an inconclusive condition if the mobile device is not inside the first boundary and not outside the second boundary.

6. The apparatus of claim 5, wherein one of the first or the second module is further configured to determine if the mobile device is within the geofence perimeter when the inconclusive conditions exist.

7. The apparatus of claim 1, further comprising a processor configured to determine the first boundary and the second boundary as geometric areas relevant to the geofence perimeter.

8. The apparatus of claim 1, wherein one of the first or the second module is further configured to notify a server when the mobile device enters or exists one of the first or the second boundaries.

9. A system comprising:
a memory;
a processor;
a radio;
one or more antennas;
a first module to identify a first boundary encompassed by the geofence region and a second boundary encompassing the geofence perimeter;
a second module configured to determine if the mobile device is inside the first boundary or outside the second boundary.

10. The system of claim 9, further comprising a third module to transmit a coarse geofence location of the mobile device relative to the first boundary and/or the second boundary.

11. The system of claim 9, wherein the first boundary and the second boundary overlap.

12. The system of claim 9, wherein each of the first boundary and the second boundary is defined by a respective center coordinates and an area.

13. The system of claim 9, wherein the first module is further configured to define an inconclusive condition if the mobile device is not inside the first boundary and not outside the second boundary.

14. The system of claim 9, wherein one of the first or the second module is further configured to notify a server when the mobile device enters or exists one of the first boundary or the second boundary.

15. A method to determine a coarse geofence location of a mobile device, the method comprising:
identifying, at the device, a first boundary for the location, the first boundary enclosed by a geofence perimeter;
identifying a second boundary for the location, the second boundary enclosing the geofence perimeter; and
determining if the device is inside the first boundary or outside the second boundary.

16. The method of claim 15, wherein the first boundary and the second boundary overlap.

17. The method of claim 15, wherein each of the first boundary and the second boundary is defined by respective center coordinates and an area.

18. The method of claim 15, further comprising defining an inconclusive condition if the device is not inside the first boundary and not outside the second boundary.

19. The method of claim 18, further comprising determining if the device is within the geofence perimeter when the inconclusive conditions exist.

20. The method of claim 15, further comprising determining the first boundary and the second boundary as geometric areas relevant to the geofence perimeter.

21. The method of claim 15, further comprising notifying a server when the mobile device is either entering or exiting one of the first or the second boundaries.

22. A tangible computer-readable storage device containing a set of instructions to cause a computer to perform a process comprising identifying, at the device, a first boundary for the location, the first boundary enclosed by a geofence perimeter; identifying a second boundary for the location, the second boundary enclosing the geofence perimeter; and determining if the device inside the first boundary or an outside the second boundary.

23. The tangible computer-readable storage device of claim 22, wherein the instructions further cause the computer to define an inconclusive condition if the device is not inside the first boundary and not outside the second boundary.

24. The tangible computer-readable storage device of claim 22, wherein the instructions further cause the computer to determine if the device is within a geofence perimeter when the inconclusive conditions exist.

25. The tangible computer-readable storage device of claim 22, wherein the instructions further cause the computer to determine the first boundary and the second boundary as geometric areas relevant to the geofence perimeter.
